(19) United States
(12) Patent Application Publication
(10) Pub. No.: US 2021/0241647 A1
(43) Pub. Date: Aug. 5, 2021

(54) DEVICE AND PROGRAM FOR PERFORMING NEW TRAINING

(71) Applicant: Mentor Corporation Ltd., Osaka (JP)

(72) Inventor: Kuniyoshi NAGAI, Osaka (JP)

(21) Appl. No.: 17/049,549

(22) PCT Filed: Apr. 12, 2019
(86) PCT No.: PCT/JP2019/015997

§ 371 Date: Oct. 21, 2020

(30) Foreign Application Priority Data
Apr. 24, 2018 (JP) 2018-083056

(51) Int. Cl. G09B 17/00; G06F 3/0483; G06F 3/0484; G06F 3/0488; G09B 5/06; G09B 17/04

(52) U.S. Cl. CPC G09B 17/006; G06F 3/0483; G09B 17/04; G06F 3/0488; G09B 5/06; G06F 3/0484

(57) ABSTRACT

This device is provided with a means for flash displaying a reversed text or image, an inverted text or image, or an inverted and reversed text or image in flash mode. In one embodiment, this device is furthermore provided with a means for causing a user to undergo book-reading training. In one embodiment, the means for causing a user to undergo book-reading training may include a means for displaying a page of a book, a means for displaying a marker on the page of the book, and a means for causing the display position of the marker to change at a prescribed time interval.

### TECHNICAL FIELD

The present invention relates to a device and a program for performing new training that is effective for developing skills such as speed reading.

### BACKGROUND ART

It is conventionally known that it is possible to train the “ability to unconsciously understand”, which is essential for development of skills such as speed reading, by performing flash training wherein letters that are randomly placed on a circumference are flashingly displayed (see for example Non Patent Literature 1).

### CITATION LIST

### Non Patent Literature

Non Patent Literature 1: K. K. Asu Design, “BrainBoost”, [online], [retrieved on Apr. 12, 2018], the Internet <URL: http://brainboost.jp/system/>

### SUMMARY OF INVENTION

### Technical Problem

Conventional flash training needs to randomly place letters on a circumference. Thus, the problem to be solved of the conventional flash training lies in that although said flash training is suitable for languages using ideograms such as Japanese, said flash training is not suitable for languages using phonograms such as English. This problem to be solved was not known, but was recognized by the inventor of the present invention for the first time.

The present invention was invented for the first time based on the above-described recognition of the inventor of the present invention. The objective of the present invention is to establish new training which is effective for developing skills such as speed reading, and to provide a device and a program for performing the new training regardless of the type of the language such as Japanese or English.

### Solution to Problem

In one aspect of the present invention, the device of the present invention is a device configured to flashingly display a reversed text or image, or an inverted text or image, or an inverted and reversed text or image.

In one embodiment of the present invention, the device may comprise: a means for storing the text or image; and a means for flashingly displaying the text or image in a reversed or inverted manner or in an inverted and reversed manner.

In one embodiment of the present invention, the device may comprise: a means for storing a plurality of texts or images; and a means for flashingly displaying at least some of the plurality of texts or images in a predetermined order in a reversed or inverted manner or in an inverted and reversed manner.

In one embodiment of the present invention, the device may further comprise a means for causing a user to perform reading training.

In one embodiment of the present invention, the means for causing a user to perform reading training may comprise: a means for displaying a page of a book; a means for displaying a marker on the page of the book; and a means for changing a display position of the marker at a predetermined time interval.

In one embodiment of the present invention, the means for causing a user to perform reading training may further comprise a means for outputting a sound at the predetermined time interval, wherein a change in the display position of the marker may be synchronized with an output of the sound.

In one embodiment of the present invention, the means for causing a user to perform reading training may further comprise: a means for highlighting an area to be read indicating an area that the user should currently read on the page of the book; and a means for highlighting an area scheduled to be read indicating an area that the user should read next on the page of the book, wherein the marker may be displayed on the area to be read and/or the area scheduled to be read, and wherein an embodiment of highlighting the area to be read may be different from an embodiment of highlighting the area scheduled to be read.

In one embodiment of the present invention, the means for causing a user to perform reading training may further comprise a means for changing a display position of each of the area to be read and the area scheduled to be read at the predetermined time interval, wherein a change in the display position of each of the area to be read and the area scheduled to be read may be synchronized with a change in the display position of the marker.

In one embodiment of the present invention, the marker may comprise a touch detecting area that is able to detect a touch operation by a user, wherein the means for causing a user to perform reading training may further comprise: a means for determining whether a touch operation to the touch detecting area has been detected while the marker is displayed; and a means for outputting a result of the determination.

In one embodiment of the present invention, the device may comprise a means for evaluating a result of training of the flash display, wherein the means for causing a user to perform reading training may further comprise a means for setting an initial condition of the reading training based on a result of the evaluation.

In one embodiment of the present invention, the initial condition may comprise at least one of: a predetermined time interval of a sound generated from the device; or the number of display positions of the marker per page.

In one embodiment of the present invention, the device further may comprise a means for causing a user to perform speed listening training.

In one embodiment of the present invention, the means for causing a user to perform speed listening training may comprise: a means for setting an output speed scale factor of a sound to be output; and a means for outputting the sound to be output at the set output speed scale factor.

In one embodiment of the present invention, the means for causing a user to perform speed listening training may further comprise a means for identifying the sound to be output.

In one embodiment of the present invention, the device may comprise a means for evaluating a result of training of the flash display, wherein the means for causing a user to perform speed listening training may further comprise a means for setting an initial condition of the speed listening training based on a result of the evaluation.

In one embodiment of the present invention, the device may further comprise a means for causing a user to perform line spread training.

In one embodiment of the present invention, the means for causing a user to perform line spread training may comprise: a means for displaying a page of a book; a means for displaying a marker on the page of the book; a means for detecting that the user has touched the page of the book; and a means for changing a display position of the marker in response to detecting that the user has touched the page of the book.

In one embodiment of the present invention, the means for causing a user to perform line spread training may further comprise: a means for highlighting an area to be read indicating an area that the user should currently read on the page of the book; and a means for highlighting an area scheduled to be read indicating an area that the user should read next on the page of the book, wherein the marker may be displayed on the area to be read and/or the area scheduled to be read, and wherein an embodiment of highlighting the area to be read may be different from an embodiment of highlighting the area scheduled to be read.

In one embodiment of the present invention, the means for causing a user to perform line spread training may further comprise: a means for changing a display position of each of the area to be read and the area scheduled to be read in response to detecting that the user has touched the page of the book, wherein a change in the display position of each of the area to be read and the area scheduled to be read may be synchronized with a change in the display position of the marker.

In one embodiment of the present invention, the device may comprise a means for evaluating a result of training of the flash display, wherein the means for causing a user to perform line spread training may further comprise a means for setting an initial condition of the line spread training based on a result of the evaluation.

In one embodiment of the present invention, the initial condition may comprise the number of display positions of the marker per page.

In one aspect of the present invention, the device of the present invention comprises: a means for displaying a book having a plurality of pages; and a means for turning the plurality of pages of the book one by one at high speed.

In one aspect of the present invention, the program of the present invention is a program which is executed in a device, wherein the device comprises a processor unit, and wherein the program, when executed in the processor unit, causes the processor unit to execute at least flashingly displaying a text or image in a reversed or inverted manner or in an inverted and reversed manner.

In one aspect of the present invention, the program of the present invention is a program which is executed in a device, wherein the device comprises a processor unit, and wherein the program, when executed in the processor unit, causes the processor unit to execute at least: displaying a book having a plurality of pages; and turning the plurality of pages of the book one by one at high speed.

In one aspect of the present invention, the method of the present invention is a training method for developing a user's skill, wherein the method comprises: providing a first device comprising a means for causing the user to perform flash training and a second device comprising a means for causing the user to perform reading training to the user; using the first device to cause the user to perform flash training; and using the second device to cause the user to perform reading training.

In one embodiment of the present invention, the method may further comprise: providing a third device comprising a means for causing the user to perform speed listening training to the user; and using the third device to cause the user to perform speed listening training.

In one embodiment of the present invention, the method may further comprise: providing a fourth device comprising a means for causing the user to perform line spread training to the user; and using the fourth device to cause the user to perform line spread training.

### Advantageous Effects of Invention

According to the present invention, it is possible to provide a device and a program for performing new training that is effective for developing skills such as speed reading regardless of the type the language such as Japanese or English.

### BRIEF DESCRIPTION OF DRAWINGS

FIG. 1A A figure showing one example of transition of a screen displayed by a device for performing new flash training.

FIG. 1B A figure showing another example of transition of a screen displayed by a device for performing new flash training.

FIG. 1C A figure showing another example of transition of a screen displayed by a device for performing new flash training.

FIG. 1D A figure showing another example of transition of a screen displayed by a device for performing new flash training.

FIG. 1E A figure showing one example of an image which is reversely displayed on a screen 140.

FIG. 2 A figure showing one example of transition of a screen displayed by a device for performing new reading training.

FIG. 3 A figure showing one example of the configuration of a device for performing new flash training and new reading training and new line spread training and speed listening training.

FIG. 4 A figure showing one example of the flow of processing executed by a computer 300 in a case where a device for performing new flash training and new reading training and new line spread training and speed listening training is implemented by the computer 300.

FIG. 5 A figure showing one example of the flow of processing executed in step S406 in FIG. 4.

FIG. 6 A figure showing one example of the flow of processing executed in step S407 in FIG. 4.

FIG. 7 A figure showing one example of the flow of processing executed in step S408 in FIG. 4.

FIG. 8A A figure showing one example of the configuration of data stored in a memory unit 320.

FIG. 8B A figure showing one example of the configuration of sheet data for evaluating a result of flash training.

FIG. 8C A figure showing one example the configuration of sheet data for setting an initial condition of reading training.

FIG. 8D A figure showing one example of the configuration of sheet data for setting an initial condition of speed listening training.

FIG. 9 A figure showing one example of the flow of processing of the function of “turning pages at high speed”.

FIG. 10 A figure showing one example of the flow of a training method for developing a user's skill.

### DESCRIPTION OF EMBODIMENTS

The terms that are used herein are defined below.

* A “text” refers to one word, one phrase, one passage, one sentence, or a combination thereof.

* A “normal direction” of a text refers to a direction of a text in which the rotation angle of the text is 0° to 45° or 315° to 360°.

* A “reversed” text refers to a text in the direction wherein the rotation angle of the text is 135° to 225°.

As used herein, the rotation angle of a text is represented by 0° to 360°. Table 1 below shows the relationship between a rotation angle of a text and the text displayed in horizontal writing on a screen that corresponds to the rotation angle. Further, Table 2 below shows the relationship between a rotation angle of a text and the text displayed in vertical writing on a screen that corresponds to the rotation angle. It should be noted that a reference line is drawn adjacent to the texts displayed in each table below so that the angle of each displayed text can be readily visually recognized.

* A “normal direction” of an image refers to a direction of an image in which the rotation angle of the image is 0° to 45° or 315° to 360°.

* An “inverted text” refers to a text wherein a text in a normal direction is inverted around the longitudinal central axis in a two-dimensional plane.

* An “inverted and reversed text” refers to a text which is a reversed text and which is an inverted text.

* A “reversed” image refers to an image in the direction wherein the rotation angle of the image is 135° to 225°.

As used herein, the rotation angle of an image is represented by 0° to 360°. The relationship between a rotation angle of an image and the image displayed on a screen that corresponds to the rotation angle is the same as the relationship between a rotation angle of a text and the displayed text. Thus, detailed explanation of the relationship between a rotation angle of an image and the image displayed on a screen that corresponds to the rotation angle is omitted.

* An “inverted image” refers to an image wherein an image in a normal direction is inverted around the longitudinal central axis in a two-dimensional plane.

* An “inverted and reversed image” refers to an image which is a reversed image and which is an inverted image.

* “Flashingly display” refers to instantaneously displaying.

Embodiments of the present invention are explained hereinafter with reference to the drawings.

The inventor devised new flash training wherein a reversed text is flashingly displayed. In this new flash training, a reversed text is displayed only for an instant. A user (student) can train the “ability to unconsciously understand” by just seeing a reversed text which is displayed only for an instant without trying to read it.

Seeing a reversed text which is displayed only for an instant puts a greater strain on the brain as compared to seeing a text in a normal direction which is displayed only for an instant. In the same manner, it is considered that seeing a reversed text which is displayed only for an instant puts a greater strain on the brain as compared to seeing letters randomly placed on a circumference which are displayed only for an instant in the conventional flash training because said letters are in a normal direction (0°) although they are randomly placed. In general, it is believed that the greater the strain on the brain is, the more useful it would be for developing skills such as speed reading. Thus, new flash training wherein a reversed text is flashingly displayed is expected to achieve a greater effect than the effect of the conventional flash training.

Furthermore, new flash training wherein a reversed text is flashingly displayed enables a text in a meaningful block to be displayed while maintaining the form of the block. Thus, regardless of the type of the language such as Japanese or English, it is possible to perform flash training that puts a great strain on the brain even when using any language. Accordingly, new flash training wherein a reversed text is flashingly displayed can provide an opportunity to develop skills such as speed reading to people around the would.

Furthermore, the inventor found that not only flash display of a reversed text but also training using flash display of an inverted text and training using flash display of an inverted and reversed text also achieve a greater effect than the effect of the conventional flash training.

Furthermore, the inventor found that not only flash display of a text but also training using flash display of an image (specifically, flash display of a reversed image, flash display of an inverted image, and flash display of an inverted and reversed image) achieves a greater effect than the effect of the conventional flash training. Training using flash display of an image is more significant than training using flash display of a text in that even very young children who cannot read can perform flash training.

Further, the inventor devised new reading training. This new reading training enables a user (student) to utilize an electronic book to train the ability of dividing a page of the book into some blocks and smoothly reading each block at a predetermined rhythm instead of reading each line on the page of the book (in other words, the ability of reading sentences at the speed in the brain).

Further, the inventor devised new line spread training for enlarging a field of view so that a plurality of lines can be read. This new line spread training enables a user (student) to improve the conventional reading way in which the user reads one line by one line, and acquire a reading way in which the user reads two lines at a time or a reading way in which the user reads three lines at a time.

Further, the inventor newly found an advantage of performing speed listening training that enables listening at higher speed than normal speed after the above-described flash training and reading training. Since the right brain is well trained by the flash training and reading training, performing speed listening training after the flash training and reading training enables a user (student) to promote outputs from the right brain to the left brain, which can thereby activate information transmission from the right brain to the left brain. In this manner, if speed listening training is performed after the flash training and reading training, the right brain is already activated before the speed listening training, so that a user who can usually listen at up to double speed will be able to listen at quadruple speed. Further, if speed listening training is performed after the flash training and reading training, the right brain is already activated before the speed listening training, so that it is possible to reduce the time required for a user to be able to listen at quadruple speed. Further, performing line spread training between the reading training and speed listening training can further improve the above-described effect.

Each training and a device for performing each training are explained hereinafter.

### 1. New Flash Training

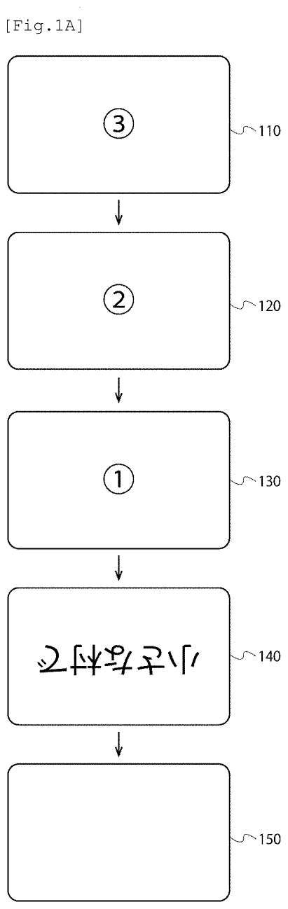

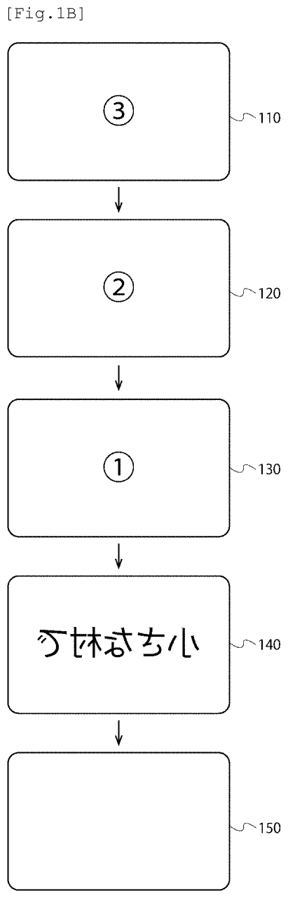

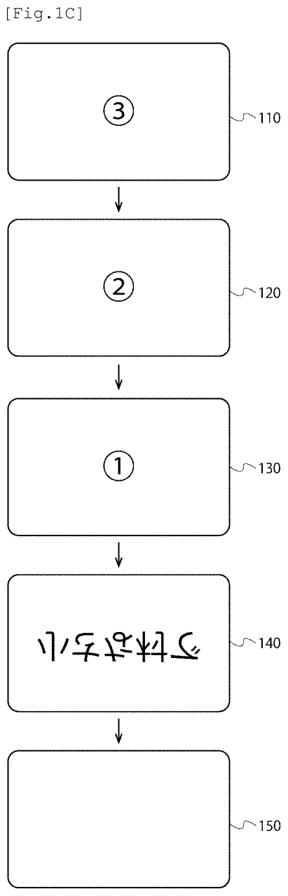

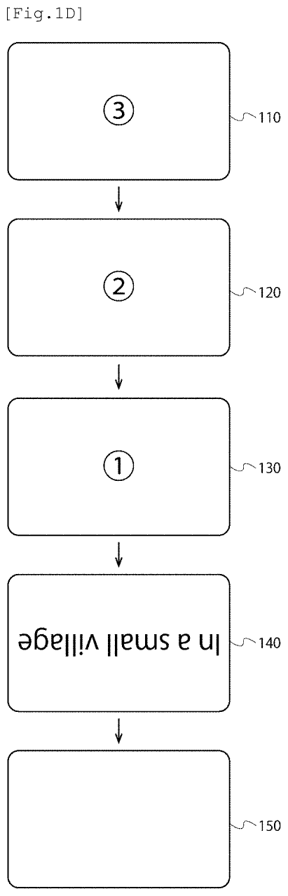

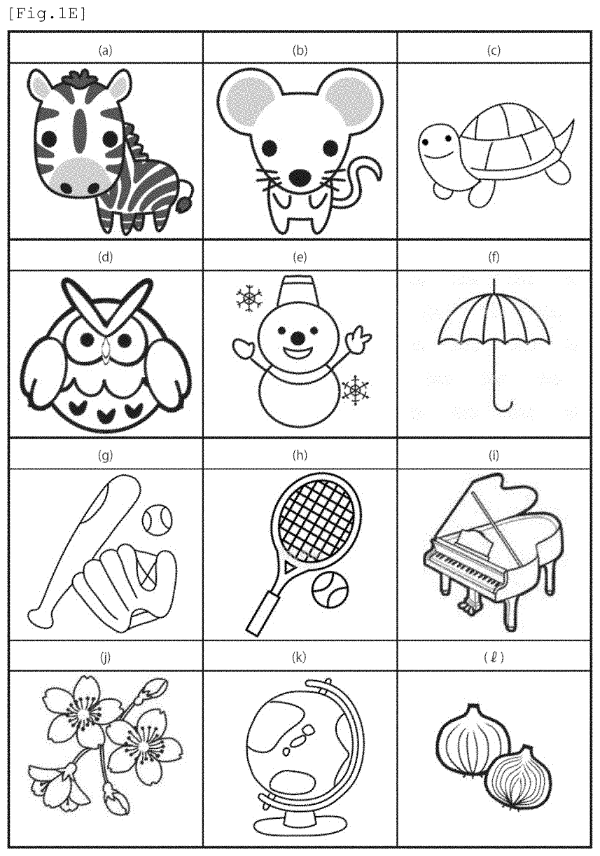

FIG. 1A shows one example of transition of a screen displayed by a device for performing new flash training.

In the example shown in FIG. 1A, the screen transits in the order of screens 110, 120, 130, 140, and 150. Specifically, countdown is displayed on the screens 110, 120, and 130, a reversed text of a Japanese text “ [symbol] ” (“In a small village” in English) is displayed on the screen 140 only for an instant, and the display of the reversed text disappears on the screen 150.

Although the screens 110, 120, and 130 on which countdown is displayed are not required in this case, countdown is preferably displayed in order to prevent a user from missing the timing when a reversed text is displayed in consideration that the reversed text is displayed for an instant. However, the displayed countdown is not limited to 3, 2, and 1, but may be 2, and 1. The number of screens on which the countdown is displayed does not matter. Further, a countdown sound or a countdown voice may be output in addition to or instead of the displayed countdown.

On the screen 140, the time during which a reversed text is displayed is preferably less than 0.6 seconds, and the time during which a reversed text is displayed may be any of 0.5 seconds, 0.4 seconds, 0.3 seconds, 0.2 seconds, and 0.1 seconds. It is preferable that the time during which a reversed text is displayed can be arbitrarily set. For example, the time during which a reversed text is displayed may be gradually set, or may be successively set. It is thereby possible to change the time during which a reversed text is displayed depending on the degree of a user's improvement in flash training. In this manner, it is possible to perform new flash training by a reversed text being displayed only for an instant (in other words, flashingly displayed). It should be noted that the time during which a reversed text is displayed may become shorter every time the reversed text is displayed. It is thereby possible to put a greater strain on the brain every time the reversed text is displayed.

Although the reversed text shown on the screen 140 consists of one line in the example shown in FIG. 1A, the present invention is not limited to this. The number of lines of the reversed text shown on the screen 140 may be any integer of 1 or greater. For example, the reversed text shown on the screen 140 may consist of two lines, or may consist of three lines. Further, although the reversed text shown on the screen 140 is in horizontal writing from left to right in the example shown in FIG. 1A, the present invention is not limited to this. The reversed text shown on the screen 140 may be in horizontal writing from right to left, may be in vertical writing from top to bottom, or may be in vertical writing from bottom to top.

Further, it is possible to continuously perform new flash training for a predetermined period (e.g., 10 minutes) by repeating the transition of screens 110, 120, 130, 140, and 150 while changing a reversed text which is flashingly displayed on the screen 140 each time. The reversed text which is flashingly displayed on the screen 140 can be randomly selected from, for example, a plurality of possible texts. Alternatively, the reversed text which is flashingly displayed on the screen 140 may be set in advance.

FIG. 1B shows another example of transition of a screen displayed by a device for performing new flash training.

In the example shown in FIG. 1B, countdown is displayed on screens 110, 120, and 130, an inverted text of a text “ [symbol] ” (“In a small village” in English) is displayed on a screen 140 only for an instant, and the display of the inverted text disappears on a screen 150. According to the screen transition shown in FIG. 1B, it is possible to perform new flash training in the same manner as the screen transition shown in FIG. 1A.

FIG. 1C shows another example of transition of a screen displayed by a device for performing new flash training.

In the example shown in FIG. 1C, countdown is displayed on screens 110, 120, and 130, an inverted and reversed text of a text “ [symbol] ” (“In a small village” in English) is displayed on a screen 140 only for an instant, and the display of the inverted and reversed text disappears on a screen 150. According to the screen transition shown in FIG. 1C, it is possible to perform new flash training in the same manner as the screen transition shown in FIG. 1A.

FIG. 1D shows another example of transition of a screen displayed by a device for performing new flash training.

In the example shown in FIG. 1D, countdown is displayed on screens 110, 120, and 130, a reversed text of an English text “In a small village” is displayed on a screen 140 only for an instant, and the display of the reversed text disappears on a screen 150. According to the screen transition shown in FIG. 1D, it is possible to perform new flash training in the same manner as the screen transition shown in FIG. 1A.

In the same manner as the example shown in FIG. 13 or FIG. 1C, countdown may be displayed on the screens 110, 120, and 130, an inverted text of a text “In a small village” or an inverted and reversed text of a text “In a small village” may be displayed on the screen 140 only for an instant, and the display of the inverted text or the inverted and reversed text may disappear on the screen 150.

Although examples in which a Japanese or English reversed text is flashingly displayed were explained in the examples shown in FIG. 1A to FIG. 1D, the language to which the present invention can be applied is not limited to Japanese and English. The present invention can be applied to every language. The new flash training can thereby provide an opportunity to develop skills such as speed reading to people around the would.

Although flash display of a text was explained in the examples shown in FIG. 1A to FIG. 1D, the present invention is not limited to this. FIG. 1E shows one example of an image which is reversely displayed on a screen 140. Each image shown in FIG. 1E can be reversely displayed on the screen 140 in addition to or instead of a text. Specifically, countdown can be displayed on screens 110, 120, and 130, a reversed image can be displayed on the screen 140 only for an instant, and the display of the reversed image can disappear on a screen 150.

In the example shown in FIG. 1E, FIG. 1E(a) shows a “zebra”, FIG. 1E(b) shows a “mouse”, FIG. 1E(c) shows a “turtle”, FIG. 1E(d) shows an “owl”, FIG. 1E(e) shows a “snowman”, FIG. 1E(f) shows an “umbrella”, FIG. 1E(g) shows “baseball”, FIG. 1E(h) shows “tennis”, FIG. 1E(i) shows a “piano”, FIG. 1E(j) shows “cherry blossoms”, FIG. 1E(k) shows a “globe”, and FIG. 1E(l) shows an “onion”. However, the image which is reversely displayed on the screen 140 is not limited to the above images. The image which is reversely displayed on the screen 140 is arbitrary. For example, the image which is reversely displayed on the screen 140 may be a character of a comic, or may be a character of a cartoon. The image which is reversely displayed on the screen 140 is preferably an image that can be recognized by very young children who cannot read.

In this manner, using an image instead of a text to materialize training of flash display enables, for example, even a very young child who cannot read to perform training of flash display.

When an image is flashingly displayed on the screen 140, an inverted image may be flashingly displayed, or an inverted and reversed image may be flashingly displayed. Specifically, countdown may be displayed on the screens 110, 120, and 130, an inverted image may be displayed on the screen 140 only for an instant, and the display of the inverted image may disappear on the screen 150. Alternatively, countdown may be displayed on the screens 110, 120, and 130, an inverted and reversed image may be displayed on the screen 140 only for an instant, and the display of the inverted and reversed image may disappear on the screen 150.

### 2. New Reading Training

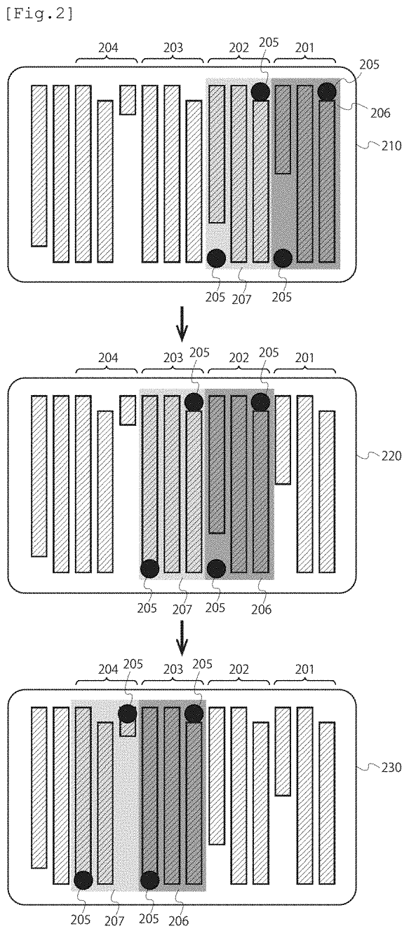

FIG. 2 shows one example of transition of a screen displayed by a device for performing new reading training. In the example shown in FIG. 2, the screen transits in the order of screens 210, 220, and 230. Specifically, a page of a book is displayed on each of the screens 210, 220, and 230 (it is supposed that this page contains a first block 201 containing a sentence of three lines, a second block 202 containing a sentence of three lines, a third block 203 containing a sentence of three lines, and a fourth block 204 containing a sentence of three lines). Markers 205 are displayed on the page of the book, and the position of a marker 205 displayed on the page of the book changes at a predetermined time interval. The page of the book displays an area to be read 206 indicating an area that a user should currently read and an area scheduled to be read 207 indicating an area that the user should read next. The display position of each of the area to be read 206 and the area scheduled to be read 207 changes in synchronization with changing the position where the marker 205 is displayed. The example shown in FIG. 2 shows how the position of the marker 205 displayed on the page of the book, the position of the area to be read 206, and the position of the area scheduled to be read 207 change as the screen transits in the order of the screens 210, 220, and 230.

The position of a marker 205 represents a position where the user should place a finger (e.g., index finger) when the user reads the page of the book by a block unit. The user can perform training of smoothly reading sentences by a block unit at a predetermined rhythm by moving the user's hand (or finger) so as to place the finger (e.g., index finger) on the marker 205 of which position changes as the position of the marker 205 changes at a predetermined time interval. It is thereby possible to train the ability of reading sentences at the speed in the brain. Furthermore, the predetermined time interval can be freely set depending on the degree of the user's improvement. This enables the user to start the training without difficulty at a pace suitable for the user.

The area to be read 206 and/or area scheduled to be read 207 may be displayed in addition to a marker 205. However, it is not required to display the area to be read 206 and/or area scheduled to be read 207.

The area to be read 206 indicates an area that the user should currently read. This area is displayed by a block unit. This enables the user to readily grasp the size of the area that the user should currently read by a block unit. Further, the user can perform training of reading sentences by a block unit by retaining visual recognition of the changing area to be read 206 with the user's eyes as the display position of the area to be read 206 changes at a predetermined time interval.

The area scheduled to be read 207 indicates an area that the user should read following the area to be read 206. In other words, the area scheduled to be read 207 indicates an area in which an area to be read 206 is scheduled to be subsequently displayed. In the example shown in FIG. 2, the area scheduled to be read 207 is displayed adjacent to the area to be read 206. In this manner, displaying the area scheduled to be read 207 adjacent to the area to be read 206 enables the user to grasp in advance the size of an area that the user should read next before actually reading the area that the user should read next. This enables the user to avoid reading sentences as if following the display of the area to be read 206.

The display embodiment of the area to be read 206 is different from the display embodiment of the area scheduled to be read 207. However, these display embodiments can be any display embodiment as long as the user can distinguish the area to be read 206 from the area scheduled to be read 207 and visually recognize said areas. For example, the area to be read 206 may be highlighted by being colored in a dark color to be displayed while the area scheduled to be read 207 may be highlighted by being colored in a light color to be displayed (in other words, the area to be read 206 and the area scheduled to be read 207 may be highlighted so that said areas are distinguished from each other by gradation of one color). Alternatively, the area to be read 206 may be highlighted by being colored in yellow to be displayed while the area scheduled to be read 207 may be highlighted by being colored in blue to be displayed (in other words, the area to be read 206 and the area scheduled to be read 207 may be highlighted so that said areas are distinguished from each other by different colors). Alternatively, the area to be read 206 may be highlighted by being enclosed by a bold line frame while the area scheduled to be read 207 may be highlighted by being enclosed by a thin line frame (in other words, the area to be read 206 and the area scheduled to be read 207 may be highlighted so that said areas are distinguished from each other by different edgings).

In addition to changing the position where a marker 205 is displayed at a predetermined time interval, a sound may be output in synchronization with changing the position where the marker 205 is displayed. This enables the user to perform training of smoothly reading sentences by a block unit at a predetermined rhythm by using both visual sense and auditory sense.

Although the shape of a marker 205 is a circle in the example shown in FIG. 2, the present invention is not limited to this. The marker 205 can have any shape. However, the marker 205 preferably has a shape on which the user can easily place a finger (e.g., index finger) because said marker represents a position where the user should place a finger (e.g., index finger).

The screen 210 shown in FIG. 2 displays markers 205 at the top of the first line contained in the first block 201 (in other words, line 1 of the first block 201), at the bottom of the last line contained in the first block 201 (in other words, line 3 of the first block 201), at the top of the first line contained in the second block 202 (in other words, line 1 of the second block 202), and at the bottom of the last line contained in the second block 202 (in other words, line 3 of the second block 202). Further, the area to be read 206 is displayed in the first block 201 while the area scheduled to be read 207 is displayed in the second block 202. In this case, it is important that the position where a marker 205 is displayed is in the upper right corner and the lower left corner of a block even when a sentence contained in the block is broken in the middle of the block. In this manner, placing the position where the marker 205 is displayed in the upper right corner and the lower left corner of a block regardless of the length of a sentence contained in the block enables the user to perform training of reading the page of the book by a block unit.

Once a predetermined time interval elapses after the screen 210 shown in FIG. 2 is displayed, the position where a marker 205 is displayed changes. As a result, on the screen 220 shown in FIG. 2, the marker 205 at the top of line 1 of the first block 201 and the marker 205 at the bottom of line 3 of the first block 201 are deleted while a new marker 205 is displayed at each of the top of line 1 of the third block 203 and the bottom of line 3 of the third block 203. Further, the position where the area to be read 206 and the area scheduled to be read 207 are displayed may also be changed in synchronization with the change in the position where a marker 205 is displayed. For example, on the screen 220 shown in FIG. 2, the display position of the area to be read 206 changes from inside the first block 201 to inside the second block 202 so that the area scheduled to be read 207 in the second block 202 would be replaced with an area to be read 206, and an area scheduled to be read 207 would be newly displayed in the third block 203. In this manner, it is possible to cause the user to be strongly aware of reading sentences by a block unit.

In the same manner, once a predetermined time interval elapses after the screen 220 shown in FIG. 2 is displayed, the position where a marker 205 is displayed changes. As a result, on the screen 230 shown in FIG. 2, the marker 205 at the top of line 1 of the second block 202 and the marker 205 at the bottom of line 3 of the second block 202 are deleted while a new marker 205 is displayed at each of the top of line 1 of the fourth block 204 and the bottom of line 3 of the fourth block 204. Further, the position where the area to be read 206 and the area scheduled to be read 207 are displayed may also be changed in synchronization with the change in the position where a marker 205 is displayed. On the screen 230 shown in FIG. 2, the display position of the area to be read 206 changes from inside the second block 202 to inside the third block 203 so that the area scheduled to be read 207 in the third block 203 would be replaced with an area to be read 206, and an area scheduled to be read 207 would be newly displayed in the fourth block 204. In this manner, it is possible to cause the user to be strongly aware of reading sentences by a block unit.

Furthermore, the first block 201 may be displayed in a suppressed manner in response to the position where the area to be read 206 is displayed being moved from the first block 201 to the second block 202 (for example, a sentence in the first block 201 may be displayed in a light color, or a sentence in the first block 201 may be hidden). This enables the user to readily recognize that the reading training in the first block 201 is completed. The display embodiment in a suppressed manner in the first block 201 in this case may differ from both the display embodiment of the area to be read 206 and the display embodiment of the area scheduled to be read 207. In the same manner, the second block 202 may be displayed in a suppressed manner in response to the position where the area to be read 206 is displayed being moved from the second block 202 to the third block 203 (for example, a sentence in the second block 202 may be displayed in a light color, or a sentence in the second block 202 may be hidden). This enables the user to readily recognize that the reading training in the second block 202 is completed. The display embodiment in a suppressed manner in the second block 202 in this case may also differ from both the display embodiment of the area to be read 206 and the display embodiment of the area scheduled to be read 207.

Although one page contains four blocks and each of the four blocks contains a sentence of three lines in the example shown in FIG. 2, the present invention is not limited to this. The number of blocks contained in one page can be any integer of 1 or greater. Further, the number of lines of a sentence contained in each block can be any integer of 1 or greater. Further, although sentences in vertical writing are displayed in the example shown in FIG. 2, sentences in horizontal writing may be displayed.

In this manner, the position where a marker 205 is displayed moves in order at a predetermined time interval, so that the user can perform training of an appropriate position where the user should place a finger and an appropriate timing by moving the user's hand (or finger) in such a manner as to follow the position where the marker 205 is displayed. Further, it is possible to readily grasp the size of an area that should be read at a time (in other words, size of each block) by performing training while visually recognizing the area to be read 206 and the area scheduled to be read 207. It is thereby possible to be strongly aware of reading sentences by a block unit. The number of display positions of markers per page is preferably decreased as the user repeatedly performs training. It is preferable to decrease the number of display positions of markers per page by, for example, displaying six markers per page→displaying four markers per page→displaying six markers per two pages→displaying two markers per page as the user repeatedly performs training. It is thereby possible to efficiently perform reading training by putting a greater strain on the brain depending on the degree of the user's improvement.

Furthermore, a marker 205 may comprise a touch detecting area that is able to detect a touch operation by the user. In this case, a device may determine whether a touch operation to the touch detecting area has been detected while the marker 205 is displayed. This enables the device to determine whether the user's finger has touched a correct position as the position where the marker 205 is displayed changes.

The display embodiment of a marker 205 may be changed when the user touches the touch detecting area comprised in the marker 205. It does not matter how the display embodiment of the marker 205 is changed. For example, the display embodiment of the marker 205 may be changed by inverting the color of the marker 205, the display embodiment of the marker 205 may be changed by highlighting the edge of the marker 205, or the display embodiment of the marker 205 may be changed by displaying the marker 205 in a blinked manner. Alternatively, when the user touches the touch detecting area comprised in the marker 205, a sound or voice indicating that the touch by the user has been detected may be output in addition to or instead of changing the display embodiment of the marker 205. Alternatively, the number of times the user has touched the touch detecting area may be add up, and a score based on the number of times added up may be displayed on the screen.

### 3. New Line Spread Training

One example of transition of a screen displayed by a device for performing new line spread training is the same as the screens 210 to 230 shown in FIG. 2. In this case, the new line spread training refers to training for increasing the number of lines that a user should read at a time. Hereinafter, only a difference between the new reading training and the new line spread training is explained.

The display position of a marker 205 automatically changes at a predetermined time interval in the new reading training, whereas the display position of a marker 205 changes in response to the user touching any location on a page of a book in the new line spread training. The same applies to the display position of an area to be read 206 and the display position of an area scheduled to be read 207.

In this manner, the user can read sentences at the user's own pace in the new line spread training. Thus, the user can steadily repeat training for increasing the number of lines of a sentence that can be read by a block unit while grasping the display position of the marker 205, the range of the area to be read 206, and the range of the area scheduled to be read 207.

### 4. Speed Listening Training

The speed listening training in the present invention is training of repeatedly listening to a sound which is output at higher speed than normal speed (sound for speed listening training), thereby becoming able to listen to the sound which is output at the higher speed. The speed listening training in the present invention can be any known speed listening training.

### 5. Configuration of a Device for Performing New Flash Training and New Reading Training and New Line Spread Training and Speed Listening Training

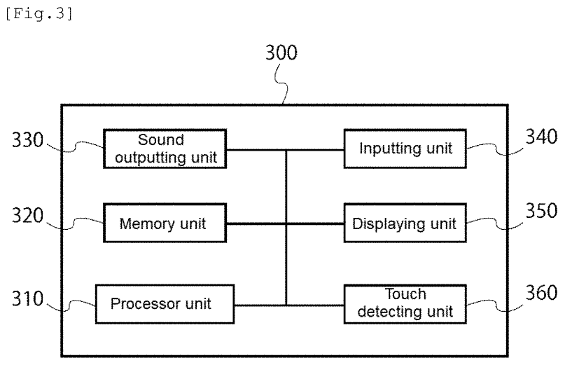

FIG. 3 shows one example of the configuration of a device for performing new flash training and new reading training and new line spread training and speed listening training.

In the example shown in FIG. 3, a device for performing new flash training and new reading training and new line spread training and speed listening training is implemented by a computer 300.

The computer 300 comprises a processor unit 310 comprising one or more CPUs (central processing unit), a memory unit 320, a sound outputting unit 330, an inputting unit 340, a displaying unit 350, and a touch detecting unit 360.

The memory unit 320 stores a program which is necessary for executing processing, data which is necessary for executing the program, and the like. In this case, it does not matter how the program is stored in the memory unit 320. For example, the program may be pre-installed in the memory unit 320. Alternatively, the program may be installed in the memory unit 320 by being downloaded via a network such as Internet, or may be installed in the memory unit 320 via a storage medium such as an optical disc or a USB.

The processor unit 310 controls the overall operation of the computer 300. The processor unit 310 reads out a program stored in the memory unit 320 and executes the program. This enables the computer 300 to function as a device for executing a desired step.

The sound outputting unit 330 is configured to be able to output a sound.

The inputting unit 340 is configured to be able to receive an input (e.g., a user input). One example of the inputting unit 340 includes, but is not limited to, a microphone, a keyboard, and a touch board.

The displaying unit 350 is configured to be able to display information (e.g., a reversed text, a page of a book, a marker).

The touch detecting unit 360 is configured to be able to detect a touch by a user.

Although an example in which the computer 300 comprises the processor unit 310, the memory unit 320, the sound outputting unit 330, the inputting unit 340 and the displaying unit 350 was explained in the example shown in FIG. 3, the present invention is not limited to this.

For example, the displaying unit 350 does not necessarily need to be built in the computer 300. The displaying unit 350 may be a displaying device external to the computer 300, or may be a part of a user device (e.g., a smartphone or a tablet) external to the computer 300. In this case, the displaying device and the user device are configured to be able to be connected to the computer 300 via a wired, wireless, or any type of a network. In this manner, when the displaying unit 350 is external to the computer 300, the computer 300 only needs to be configured to have a means for displaying necessary information (by the displaying unit 350 external to the computer 300) (in other words, function of controlling the displaying unit 350 to display necessary information). Such a configuration also remains within the scope of the present invention.

In the same manner, the touch detecting unit 360 does not necessarily need to be built in the computer 300. The touch detecting unit 360 may be a touch detecting device external to the computer 300, or may be a part of a user device (e.g., a smartphone or a tablet) external to the computer 300. In this case, the touch detecting device and the user device are configured to be able to be connected to the computer 300 via a wired, wireless, or any type of a network. In this manner, when the touch detecting unit 360 is external to the computer 300, the computer 300 only needs to be configured to have a means for detecting a touch by a user (by the touch detecting unit 360 external to the computer 300) (in other words, function of controlling the touch detecting unit 360 to detect a touch by a user). Such a configuration also remains within the scope of the present invention.

In the same manner, the sound outputting unit 330 does not necessarily need to be built in the computer 300. The sound outputting unit 330 may be a sound outputting device (e.g., an external speaker) external to the computer 300, or may be a part of a user device (e.g., a smartphone or a tablet) external to the computer 300. The sound outputting device and the user device are configured to be able to be connected to the computer 300 via a wired, wireless, or any type of a network. In this manner, when the sound outputting unit 330 is external to the computer 300, the computer 300 only needs to be configured to have a means for generating a necessary sound (by the sound outputting unit 330 external to the computer 300) (in other words, function of controlling the sound outputting unit 330 to generate a necessary sound). Such a configuration also remains within the scope of the present invention.

In the same manner, the inputting unit 340 does not necessarily need to be built in the computer 300. The inputting unit 340 may be an inputting device (e.g., a microphone) external to the computer 300, or may be a part of a user device (e.g., a smartphone or a tablet) external to the computer 300. The inputting device and the user device are configured to be able to be connected to the computer 300 via a wired, wireless, or any type of a network. In this manner, when the inputting unit 340 is external to the computer 300, the computer 300 only needs to be configured to have a means for inputting necessary information (by the inputting unit 340 external to the computer 300) (in other words, function of controlling the inputting unit 340 to input necessary information). Such a configuration also remains within the scope of the present invention.

Although an example in which a device for performing new flash training and new reading training and new line spread training and speed listening training is implemented by the computer 300 was explained in the example shown in FIG. 3, the present invention is not limited to this. Any configuration can be employed for a device for performing new flash training and new reading training and new line spread training and speed listening training as long as a step equivalent to a desired step executed by the computer 300 is executed. For example, a device for performing new flash training and new reading training and new line spread training and speed listening training may be implemented by a circuit wired on a substrate. Such a configuration also remains within the scope of the present invention.

Alternatively, a device for performing new flash training and new reading training and new line spread training and speed listening training may be implemented by a single device, or may be implemented by a plurality of devices. For example, a device for performing new flash training may be implemented by a first device, a device for performing new reading training may be implemented by a second device, a device for performing new line spread training may be implemented by a third device, and a device for performing speed listening training may be implemented by a fourth device, wherein the first device, the second device, the third device, and the fourth device may be separate. In this case, the first device, the second device, the third device, and the fourth device may be connected via any means such as a network. Alternatively, a device for performing two of the new flash training and new reading training and new line spread training and speed listening training may be implemented by a fifth device, a device for performing one of the remaining two of the new flash training and new reading training and new line spread training and speed listening training may be implemented by a sixth device, and a device for performing the other of the remaining two of the new flash training and new reading training and new line spread training and speed listening training may be implemented by a seventh device, wherein the fifth device, the sixth device, and the seventh device may be separate. In this case, the fifth device, the sixth device, and the seventh device may be connected via any means such as a network. Alternatively, a device for performing two of the new flash training and new reading training and new line spread training and speed listening training may be implemented by a eighth device, and a device for performing the remaining two of the new flash training and new reading training and new line spread training and speed listening training may be implemented by a ninth device, wherein the eighth device and the ninth device may be separate. In this case, the eighth device and the ninth device may be connected via any means such as a network. Alternatively, a device for performing three of the new flash training and new reading training and new line spread training and speed listening training may be implemented by a tenth device, and a device for performing the remaining one of the new flash training and new reading training and new line spread training and speed listening training may be implemented by an eleventh device, wherein the tenth device and the eleventh device may be separate. In this case, the tenth device and the eleventh device may be connected via any means such as a network. Such a configuration also remains within the scope of the present invention.

### 6. Flow of Processing Executed in a Computer

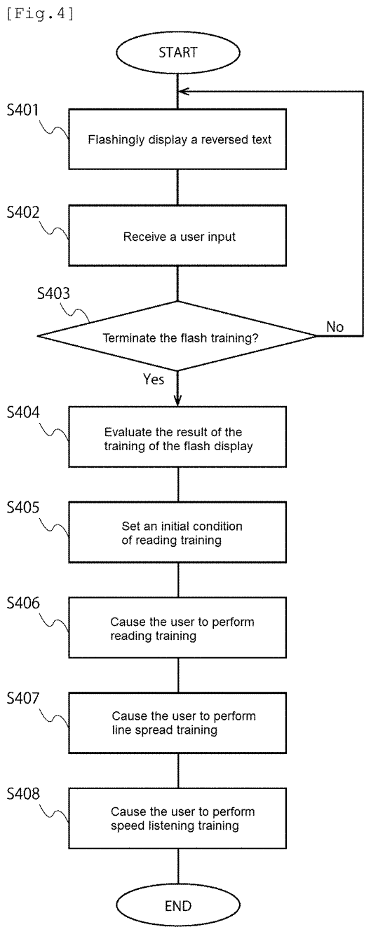

FIG. 4 shows one example of the flow of processing executed by the computer 300 in a case where a device for performing new flash training and new reading training and new line spread training and speed listening training is implemented by the computer 300. This processing is executed by, for example, the processor unit 310 comprised in the computer 300. It should be noted that the device for performing new flash training and new reading training and new line spread training and speed listening training is provided to a user in advance. Each step shown in FIG. 4 is explained in detail hereinafter.

Step S401: Processing of flashingly displaying a reversed text is executed. This processing is accomplished by, for example, reading out a text stored in the memory unit 320 and flashingly displaying the text in a reversed manner. Alternatively, when a plurality of texts are stored in the memory unit 320, this processing may be accomplished by reading out at least some of the plurality of texts stored in the memory unit 320 and flashingly displaying the at least some texts in a reversed manner in a predetermined order. It is preferable that the at least some texts that are read out from the memory unit 320 are randomly selected. One example of the screen displayed by the displaying unit 350 of the computer 300 by execution of this processing is as described above with reference to FIG. 1A to FIG. 1D.

In addition to or instead of step S401, processing of flashingly displaying a reversed image may be executed in step S401′. This processing may be accomplished by, for example, reading out an image stored in the memory unit 320 and flashingly displaying the image in a reversed manner. Alternatively, when a plurality of images are stored in the memory unit 320, this processing may be accomplished by reading out at least some of the plurality of images stored in the memory unit 320 and flashingly displaying the at least some images in a reversed manner in a predetermined order. It is preferable that the at least some images that are read out from the memory unit 320 are randomly selected. One example of the screen displayed by the displaying unit 350 of the computer 300 by execution of this processing is as described above with reference to FIG. 1A to FIG. 1E.

Step S402: Processing of receiving a user input is executed. In this case, the user input is for a user to answer what the flashingly displayed text was. Alternatively, the user input is for the user to answer what the flashingly displayed image was. One example of the user input includes, but is not limited to, voice data output from a microphone, which is one example of the inputting unit 340, letter string data output from a keyboard, which is one example of the inputting unit 340, and data indicating a choice selected from a plurality of choices output from a touch board, which is one example of the inputting unit 340. The processor unit 310 is able to receive the voice data or letter string data or data indicating a choice as a user input. The received user input is temporarily stored in the memory unit 320, and referred to in step S404 described below.

Step S403: Processing of determining whether the flash training is terminated is executed. This processing is accomplished by, for example, determining whether the processing of flashingly displaying a reversed text in step S401 has been executed a predetermined number of times or for a predetermined period of time. Alternatively, this processing is accomplished by, for example, determining whether the processing of flashingly displaying a reversed image in step S401′ has been executed a predetermined number of times or for a predetermined period of time. If the determination result is “Yes”, the processing advances to step S404. If the determination result is “No”, the processing returns to step S401 or step S401′.

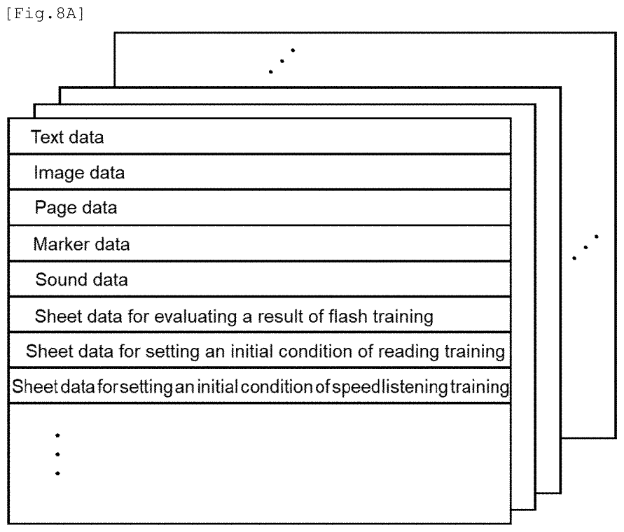

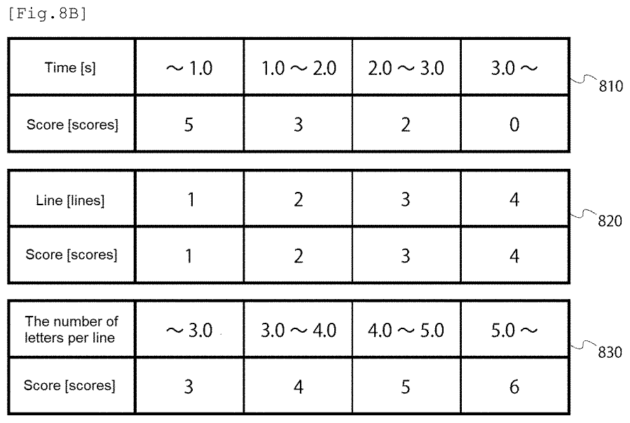

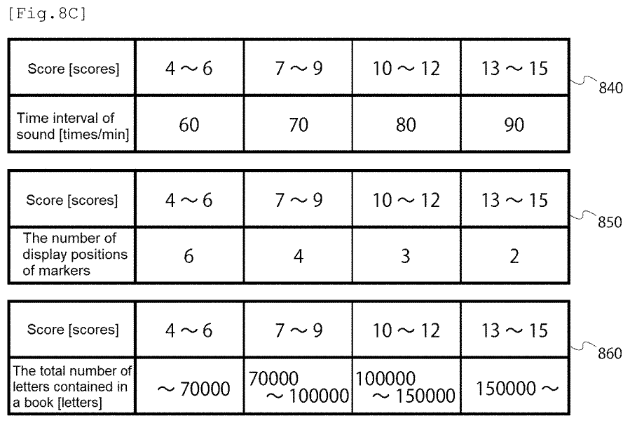

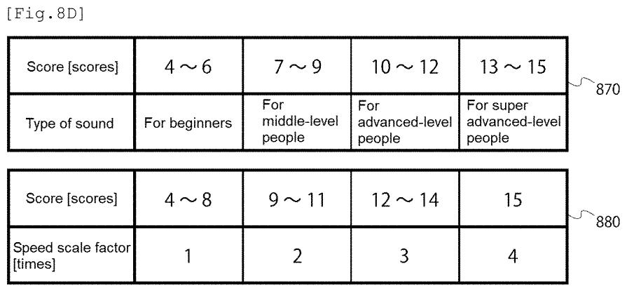

Step S404: Processing of evaluating the result of the flash training is executed. This processing is accomplished by, for example, determining whether the text flashingly displayed in a reversed manner in step S401 matches the user input received in step S402 (in other words, the text that the user answered) and evaluating the determination result. Alternatively, this processing is accomplished by, for example, determining whether the image flashingly displayed in a reversed manner in step S401′ matches the user input received in step S402 (in other words, the image that the user answered) and evaluating the determination result. The determination result is evaluated by, for example, referring to sheet data for evaluating a result of flash training which will be described below (FIG. 8B). However, step S404 is not a required step.

Step S405: Processing of setting an initial condition of reading training based on the evaluation of the result of the flash training is executed. This processing is accomplished by, for example, setting an initial condition of the reading training (e.g., a time interval of a sound, the number of display positions of markers per page, the total number of letters contained in a book, or the like) based on a score. For example, the initial condition of the reading training is set by referring to sheet data for setting an initial condition of reading training which will be described below (FIG. 8C). However, step S405 is not a required step.

Furthermore, processing of setting an initial condition of line spread training based on the evaluation of the result of the flash training may be further executed in step S405′ in addition to or instead of step S405. This processing is accomplished by, for example, setting an initial condition of the line spread training (e.g., the number of display positions of markers per page, the total number of letters contained in a book, or the like) based on a score. For example, the initial condition of the line spread training can be set in the same manner as a method for setting the initial condition of the reading training by referring to sheet data for setting an initial condition of reading training which will be described below (FIG. 8C).

Furthermore, processing of setting an initial condition of speed listening training based on the evaluation of the result of the flash training may be further executed in step S405″ in addition to or instead of step S405. This processing is accomplished by, for example, setting an initial condition of the speed listening training (e.g., the type of the sound for speed listening training, the output speed scale factor of the sound for speed listening training, or the like) based on a score. For example, the initial condition of the speed listening training is set in the same manner as a method for setting the initial condition of the speed listening training by referring to sheet data for setting an initial condition of speed listening training which will be described below (FIG. 8D).

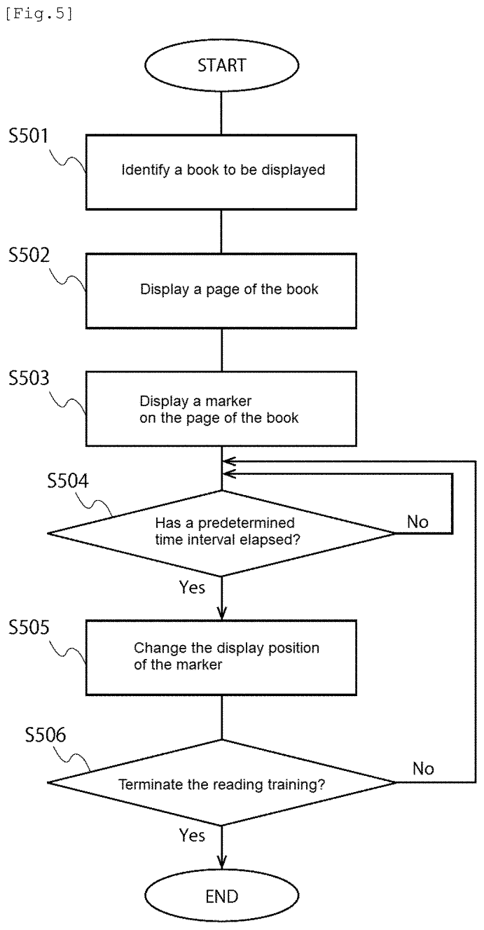

Step S406: Processing of causing the user to perform reading training is executed. This processing will be described below with reference to FIG. 5.

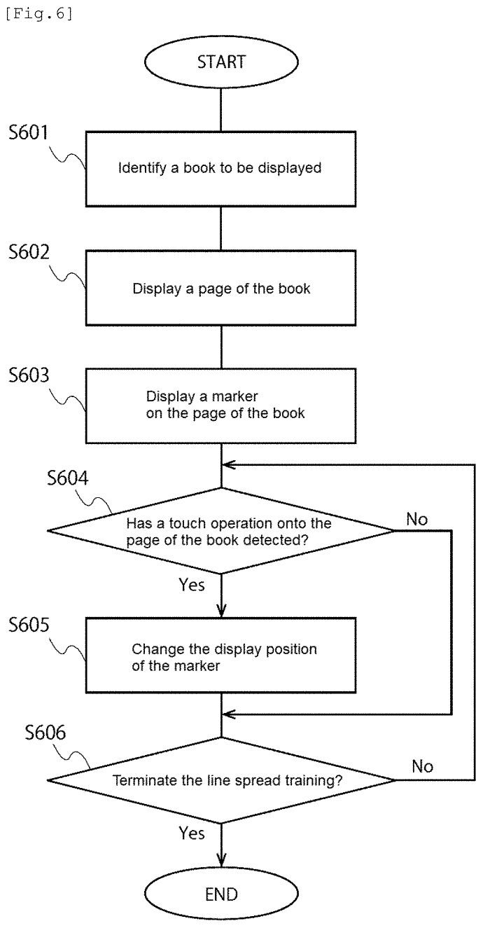

Step S407: Processing of causing the user to perform line spread training is executed. This processing will be described below with reference to FIG. 6. However, this step S407 is not a required step.

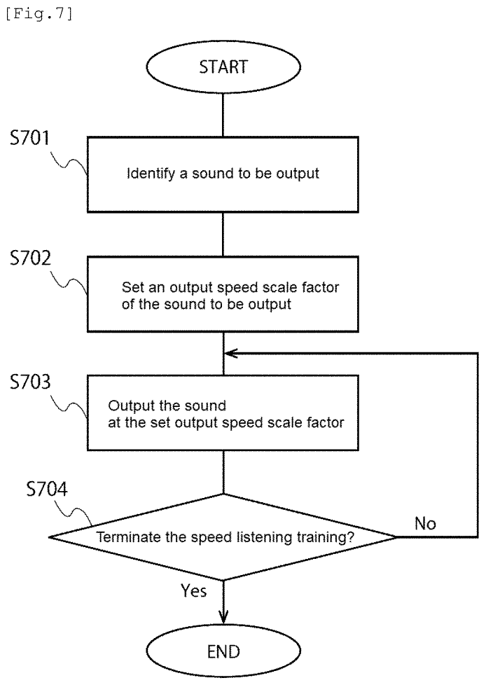

Step S408: Processing of causing the user to perform speed listening training is executed. This processing will be described below with reference to FIG. 7. However, this step S408 is not a required step.

Although flash display of a reversed text and flash display of a reversed image were explained in the above-described embodiment, the present invention is not limited to this. For example, an inverted text may be flashingly displayed, an inverted and reversed text may be flashingly displayed, an inverted image may be flashingly displayed, or an inverted and reversed image may be flashingly displayed instead of flash display of a reversed text and flash display of a reversed image.

Further, although an example in which a device for performing new flash training and new reading training and new line spread training and speed listening training is provided to a user in advance was explained in the above-described embodiment, the present invention is not limited to this. When step S407 and/or step S408 in FIG. 4 are omitted, a device for performing at least new flash training and new reading training can be provided to a user.

FIG. 5 shows one example of the flow of processing executed in step S406 in FIG. 4. This processing is executed by, for example, the processor unit 310 comprised in the computer 300. Each step shown in FIG. 5 is explained in detail hereinafter.

Step S501: Processing of identifying a book to be displayed is executed. This processing is accomplished by, for example, identifying a book from a plurality of books stored in the memory unit 320 according to the initial condition set in step S405 in FIG. 4. Alternatively, this processing may be accomplished by randomly selecting a book from a plurality of books stored in the memory unit 320. Alternatively, this processing may be accomplished by the user selecting a book from a plurality of books that are set by the user in advance.

Step S502: Processing of displaying a page of the book identified in Step S501 is executed. This processing is accomplished by, for example, the processor unit 310 transmitting a control signal to the displaying unit 350 in order to cause the displaying unit 350 to display a page of the identified book.

Step S503: Processing of displaying a marker on the page of the book is executed. This processing is accomplished by, for example, the processor unit 310 transmitting a control signal to the displaying unit 350 in order to cause the displaying unit 350 to display a marker on the page of the book. In this case, the number of display positions of markers per page can be changed according to, for example, the initial conditions set in step S405 in FIG. 4. One example of the marker is a marker 205 shown in FIG. 2. A marker comprises a touch detecting area that is able to detect a touch operation by the user.

Step S504: After the processing of step S503, processing of determining whether a predetermined time interval has elapsed is executed. If the determination result is “Yes”, the processing advances to step S505. If the determination result is “No”, the processing returns to step S504.

Step S505: Processing of changing the position of the marker displayed on the page in step S503 is executed. This processing is accomplished by, for example, the processor unit 310 transmitting a control signal to the displaying unit 350 in order to cause the displaying unit 350 to display a marker in a new position on the page after a predetermined time interval has elapsed from the display of the marker on the page in step S504. When the page of the book is divided into a plurality of blocks, for example, a marker at the top of the first line contained in the first block of the plurality of blocks and a marker at the bottom of the last line contained in the first block may be changed to the top of the first line contained in the second block of the plurality of blocks (e.g., the third block 203) and the bottom of the last line contained in the second block, respectively.

Step S506: Processing of determining whether the reading training is terminated is executed. This processing is accomplished by, for example, determining whether the determination processing in step S504 has been executed a predetermined number of times, or whether the processing from steps S501 to S505 has been executed for a predetermined period of time. If the determination result is “Yes”, the processing is terminated. If the determination result is “No”, the processing returns to step S504.

Furthermore, in step S503 in FIG. 5, the computer 300 (in particular, the processor unit 310 comprised in the computer 300) may further execute processing of highlighting an area to be read 206 and an area scheduled to be read 207 on the page of the book, and in step S505, the computer 300 (in particular, the processor unit 310 comprised in the computer 300) may execute processing of changing the display position of each of the area to be read 206 and the area scheduled to be read 207. In this case, the change in the display position of each of the area to be read 206 and the area scheduled to be read 207 is preferably synchronized with the change in the display position of the marker. Furthermore, the embodiment of highlighting the area to be read 206 is different from the embodiment of highlighting the area scheduled to be read 207. Further, one example of how the display position of each of the area to be read 206 and the area scheduled to be read 207 is changed is as explained with reference to FIG. 2. Furthermore, processing wherein when the display position of the area to be read 206 is changed, the display position of the area to be read 206 before the change is displayed in a suppressed manner may be executed. One example of this display in a suppressed manner is also as explained with reference to FIG. 2.

Further, the computer 300 (in particular, the processor unit 310 comprised in the computer 300) may execute processing of outputting a sound at a predetermined time interval at any timing after step S502 and before step S504. This processing is accomplished by, for example, the processor unit 310 transmitting a control signal to the sound outputting unit 330 in order to cause the sound outputting unit 330 to output a sound at a predetermined time interval. In this case, the predetermined time interval (in other words, time interval of a sound) can be changed according to, for example, the initial condition set in step S405 in FIG. 4. One example of the sound which is output from the sound outputting unit 330 (sound for reading training) includes, but is not limited to, a metronome sound. The sound which is output from the sound outputting unit 330 (sound for reading training) can be any sound. For example, the sound which is output from the sound outputting unit 330 (sound for reading training) may be a sound which is set by the user in advance.

Further, the computer 300 (in particular, the processor unit 310 comprised in the computer 300) may execute processing of determining whether a touch operation to the touch detecting area by the user has been detected at any timing after step S503 and before step S506. This processing is accomplished by, for example, the processor unit 310 transmitting a control signal to the touch detecting unit 360 in order to cause the touch detecting unit 360 to determine whether the user has made a touch operation to the touch detecting area comprised in a marker displayed on the page. Furthermore, when the computer 300 (in particular, the processor unit 310 comprised in the computer 300) has determined that a touch operation to the touch detecting area by the user was detected, processing of presenting the result of the determination to the user may be further executed. This processing is accomplished by, for example, the processor unit 310 transmitting a control signal to the displaying unit 350 in order to cause the displaying unit 350 to change the display embodiment of the marker (e.g., inverting the color of the marker, or highlighting the edge of the marker, or displaying the marker in a blinked manner). Alternatively, this processing may be accomplished by the processor unit 310 transmitting a control signal to the sound outputting unit 330 in order to cause the sound outputting unit 330 to output a sound (sound for reading training). Alternatively, this processing may be accomplished by the processor unit 310 transmitting a control signal to the displaying unit 350 in order to cause the displaying unit 350 to display a score based on the determination result.

FIG. 6 shows one example of the flow of processing executed in step S407 in FIG. 4. This processing is executed by, for example, the processor unit 310 comprised in the computer 300. Each step shown in FIG. 6 is explained in detail hereinafter.

Step S601: Processing of identifying a book to be displayed is executed. This processing corresponds to step S501 in FIG. 5.

Step S602: Processing of displaying a page of the book identified in step S601 is executed. This processing corresponds to step S502 in FIG. 5.

Step S603: Processing of displaying a marker on the page of the book is executed. This processing corresponds to step S503 in FIG. 5.

Step S604: Processing of determining whether a touch operation onto the page of the book by the user has been detected is executed. This processing is accomplished by, for example, the processor unit 310 transmitting a control signal to the touch detecting unit 360 in order to cause the touch detecting unit 360 to determine whether the user has made a touch operation to the page of the book. If the determination result is “Yes”, the processing advances to step S505. If the determination result is “No”, the processing advances to step S506.

Step S605: In response to detecting a touch operation to the touch detecting area by the user, processing of changing the position of the marker displayed on the page in step S603 is executed. This processing corresponds to step S505 in FIG. 5.

Step S606: Processing of determining whether the line spread training is terminated is executed. This processing is accomplished by, for example, determining whether the processing from step S601 to step S605 has been executed for a predetermined period of time. If the determination result is “Yes”, the processing is terminated. If the determination result is “No”, the processing returns to step S604.

Furthermore, in step S603 in FIG. 6, the computer 300 (in particular, the processor unit 310 comprised in the computer 300) may further execute processing of highlighting an area to be read 206 and an area scheduled to be read 207 on the page of the book, and in step S605, the computer 300 (in particular, the processor unit 310 comprised in the computer 300) may execute processing of changing the display position of each of the area to be read 206 and the area scheduled to be read 207 (for example, in response to detecting that that the user has touched the page of the book). In this case, the change in the display position of each of the area to be read 206 and the area scheduled to be read 207 is preferably synchronized with the change in the display position of the marker. Furthermore, the embodiment of highlighting the area to be read 206 is different from the embodiment of highlighting the area scheduled to be read 207. Further, one example of how the display position of each of the area to be read 206 and the area scheduled to be read 207 is changed is as explained with reference to FIG. 2. Furthermore, processing wherein when the display position of the area to be read 206 is changed, the display position of the area to be read 206 before the change is displayed in a suppressed manner may be executed. One example of this display in a suppressed manner is also as explained with reference to FIG. 2.

FIG. 7 shows one example of the flow of processing executed in step S408 in FIG. 4. This processing is executed by, for example, the processor unit 310 comprised in the computer 300. Each step shown in FIG. 7 is explained in detail hereinafter.

Step S701: Processing of identifying a sound to be output is executed. This processing is accomplished by, for example, identifying a sound for speed listening training from a plurality of sounds for speed listening training stored in the memory unit 320 according to the initial condition set in step S405″ in FIG. 4. Alternatively, this processing may be accomplished by randomly identifying a sound for speed listening training from a plurality of sounds for speed listening training stored in the memory unit 320. Alternatively, this processing may be accomplished by the user selecting a sound for speed listening training from a plurality of sounds for speed listening training that are set by the user in advance.

Step S702: Processing of setting an output speed scale factor of the sound to be output is executed. This processing is accomplished by, for example, identifying and setting an output speed scale factor from a plurality of output speed scale factors stored in the memory unit 320 according to the initial condition set in step S405″ in FIG. 4. Alternatively, this processing may be accomplished by randomly identifying and setting an output speed scale factor from a plurality of output speed scale factors stored in the memory unit 320. Alternatively, this processing may be accomplished by the user selecting and setting an output speed scale factor from a plurality of output speed scale factors that are set by the user in advance.

Step S703: Processing of outputting the sound for speed listening training identified in step S701 at the output speed scale factor set in step S702 is executed.

Step S704: Processing of determining whether the speed listening training is terminated is executed. This processing is accomplished by, for example, determining whether an input for terminating the speed listening training has been received by the inputting unit 340, or whether the processing of step S703 has been executed for a predetermined period of time. If the determination result is “Yes”, the processing is terminated. If the determination result is “No”, the processing returns to step S703.

Although it was explained that a sound to be output is identified in step S701 in the example shown in FIG. 7, the present invention is not limited to this. For example, step S701 may be omitted, and a predetermined sound for speed listening training may be output in step S703.

FIG. 8A shows one example of the configuration of data stored in a memory unit 320.

The memory unit 320 stores text data representing a text to be flashingly displayed, image data representing an image to be flashingly displayed, page data representing a page of a book for reading training, marker data representing an attribute of a marker such as shape or color, sound data representing a sound output from the sound outputting unit 330 (e.g., sound for reading training, sound for speed listening training), sheet data for evaluating a result of flash training, sheet data for setting an initial condition of reading training, sheet data for evaluating a result of speed listening training or the like.

FIG. 8B shows one example of the configuration of sheet data for evaluating a result of flash training.

In the example shown in FIG. 8B, the sheet data for evaluating a result of flash training comprises: a sheet 810 representing the corresponding relationship between the time required from displaying of a text and a user input and the score; a sheet 820 representing the corresponding relationship between the number of lines of a text which is flashingly displayed and the score; and a sheet 830 representing the corresponding relationship between the number of letters per line of a text which is flashingly displayed and the score. However, the present invention is not limited to this.

In the example shown in FIG. 8B, the sheet 810 shows that when the time required from displaying of a text to a user input is less than 1.0 second, the score is 5, when the time required from displaying of a text to a user input is 1.0 second or greater and less than 2.0 seconds, the score is 3, when the time required from displaying of a text to a user input is 2.0 seconds or greater and less than 3.0 seconds, the score is 2, and when the time required from displaying of a text to a user input is 3.0 seconds or greater, the score is 0.

In the example shown in FIG. 8B, the sheet 820 shows that when the number of lines of a text which is flashingly displayed is 1, the score is 1, when the number of lines of a text which is flashingly displayed is 2, the score is 2, when the number of lines of a text which is flashingly displayed is 3, the score is 3, and when the number of lines of a text which is flashingly displayed is 4, the score is 4.

In the example shown in FIG. 8B, the sheet 830 shows that when the number of letters per line of a text which is flashingly displayed is less than 3.0, the score is 3, when the number of letters per line of a text which is flashingly displayed is 3.0 or greater and less than 4.0, the score is 4, when the number of letters per line of a text which is flashingly displayed is 4.0 or greater and less than 5.0, the score is 5, and when the number of letters per line of a text which is flashingly displayed is 5.0 or greater, the score is 5.

The evaluation of the result of the flashingly may be represented as, for example, the sum of the scores of each of the sheet 810, sheet 820, and sheet 830. Alternatively, said evaluation may be represented as the sum of the scores of the sheet 810 multiplied by a predetermined scale factor, the scores of the sheet 820 multiplied by the predetermined scale factor, and the scores of the sheet 830 multiplied by the predetermined scale factor.

For example, when a text of three lines, “I” “went out” “early in the morning”, is flashingly displayed and the user inputs a correct answer in 1.5 seconds from displaying of the text, 3 scores will be obtained with reference to the sheet 810, 3 scores will be obtained with reference to the sheet 820, and 5 scores will be obtained with reference to the sheet 830. This indicates that the evaluation (scores) of the result of the flash training is 3 scores+3 scores+5 scores=11 scores.

Although an example in which each of the time, the number of lines, and the number of letters per line is classified into four was explained in the example shown in FIG. 8B, the present invention is not limited to this. The number of classification of each of the time, the number of lines, and the number of letters per line is any integer of 2 or greater.

FIG. 8C shows one example the configuration of sheet data for setting an initial condition of reading training.

In the example shown in FIG. 8C, the sheet data for setting an initial condition of reading training comprises: a sheet 840 representing the corresponding relationship between the output time interval of a sound (sound for reading training) and the score; a sheet 850 representing the corresponding relationship between the number of display positions of markers per page and the score; and a sheet 860 representing the corresponding relationship between the total number of letters contained in a book and the score. However, the present invention is not limited to this.

In the example shown in FIG. 8C, the sheet 840 shows that when the score is 4 to 6, the output time interval of a sound for reading training is 60 times/minute, when the score is 7 to 9, the output time interval of a sound for reading training is 70 times/minute, when the score is 10 to 12, the output time interval of a sound for reading training is 80 times/minute, and when the score is 13 to 15, the output time interval of a sound for reading training is 90 times/minute.

In the example shown in FIG. 8C, the sheet 850 shows that when the score is 4 to 6, the number of display positions of markers per page is 6, when the score is 7 to 9, the number of display positions of markers per page is 4, when the score is 10 to 12, the number of display positions of markers per page is 3, and when the score is 13 to 15, the number of display positions of markers per page is 2.

In the example shown in FIG. 8C, the sheet 860 shows that when the score is 4 to 6, a book having less than 70000 letters in total is selected, when the score is 7 to 9, a book having 70000 or greater and less than 100000 letters in total is selected, when the score is 10 to 12, a book having 100000 or greater and less than 150000 letters in total is selected, and when the score is 13 to 15, a book having 150000 or greater letters in total is selected.

For example, when the evaluation (scores) of the result of the flash training is 11, the initial condition of the reading training is set so that a sound of which time interval is 80 times/minute is output, there are 3 display positions of markers per page, a book having 100000 or greater and less than 150000 letters in total is selected, and the selected book is displayed on the displaying unit 350. In this manner, it is possible to automatically set the initial condition of the reading training depending on the evaluation (scores) of the result of the flash training. It is thereby possible to try to optimize the training efficiency depending on the degree of the user's improvement. Furthermore, any book may be selected from the books having 100000 or greater and less than 150000 letters in total in any manner. For example, a book to be displayed on the displaying unit 350 may be randomly selected by the computer 300 from the books having 100000 or greater and less than 150000 letters in total, or a book to be displayed on the displaying unit 350 may be selected by the user from the books having 100000 or greater and less than 150000 letters in total.

Although an example in which the score is classified into four (in other words, four types of scores of 4 to 6, 7 to 9, 10 to 12 and 13 to 15) was explained in the example shown in FIG. 8C, the present invention is not limited to this. The number of classification of scores is any integer of 2 or greater.

FIG. 8D shows one example of the configuration of sheet data for setting an initial condition of speed listening training.

In the example shown in FIG. 8D, the sheet data for setting an initial condition of speed listening training comprises: a sheet 870 representing the corresponding relationship between the type of a sound for speed listening training and the score; and a sheet 880 representing the corresponding relationship between the output speed scale factor of a sound for speed listening training and the score. However, the present invention is not limited to this.

In the example shown in FIG. 8D, the sheet 870 shows that when the score is 4 to 6, the type of a sound for speed listening training is for beginners, when the score is 7 to 9, the type of a sound for speed listening training is for middle-level people, when the score is 10 to 12, the type of a sound for speed listening training is for advanced-level people, and when the score is 13 to 15, the type of a sound for speed listening training is for super advanced-level people. Furthermore, a plurality of sounds for speed listening training are classified into a sound for beginners, a sound for middle-level people, a sound for advanced-level people, and a sound for super advanced-level people in advance depending on the number of words and/or the degree of difficulty in listening of a language which is output or the like.

In the example shown in FIG. 8D, the sheet 880 shows that when the score is 4 to 8, the output speed scale factor of a sound for speed listening training is 1 (normal speed), when the score is 7 to 9, the output speed scale factor of a sound for speed listening training is 2, when the score is 10 to 12, the output speed scale factor of a sound for speed listening training is 3, and when the score is 13 to 15, the output speed scale factor of a sound for speed listening training is 4.

For example, when the evaluation (scores) of the result of the flash training is 11, the sound for advanced-level people is identified for a sound for speed listening training that should be output, and the output speed scale factor of the identified sound for advanced-level people is set to be 2. In this manner, it is possible to automatically set the initial condition of the speed listening training depending on the evaluation (scores) of the result of the flash training. It is thereby possible to try to optimize the training efficiency depending on the degree of the user's improvement.

Although an example in which the score is classified into four (in other words, four types of scores of 4 to 6, 7 to 9, 10 to 12 and 13 to 15, and four types of scores of 4 to 8, 9 to 11, 12 to 14 and 15) was explained in the example shown in FIG. 8D, the present invention is not limited to this. The number of classification of scores is any integer of 2 or greater.

Although it was explained that the data shown in FIG. 8A to FIG. 8D is stored in the memory unit 320 of the computer 300 in the above explanation, the present invention is not limited to this. The data shown in FIG. 8A to FIG. 8D may be stored in, for example, a database unit connected to the computer 300. Alternatively, the data shown in FIG. 8A to FIG. 8D may be stored in a single external hard disc device of the computer 300, or may be stored on a cloud to which the computer 300 is connected via a network. In this case, the computer 300 may further comprise a communication interface unit for controlling the communication via the network.

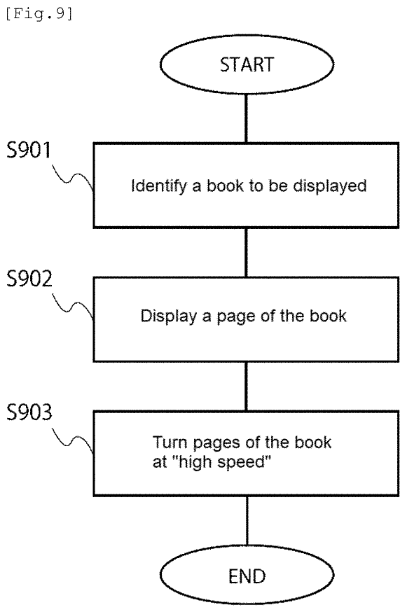

FIG. 9 shows one example of the flow of processing of the function of “turning pages at high speed”. This processing is executed by, for example, the processor unit 310 comprised in the computer 300. Each step shown in FIG. 9 is explained in detail hereinafter.

Step S901: Processing of identifying a book to be displayed is executed. Since this processing is the same as the processing in step S501 in FIG. 5, detailed explanation is omitted herein.

Step S902: Processing of displaying a page of the book identified in step S901 is executed. Since this processing is the same as the processing in Step S502 in FIG. 5, detailed explanation is omitted herein.

Step S903: Processing of turning pages of the book at “high speed” is executed.

As used herein, turning pages of a book at “high speed” refers to turning pages at speed that is able to present 70000 or greater letters in Japanese in one minute. Although such a function of “turning pages at high speed” is not necessary for normal reading, said function is considered extremely useful for the above-described new reading training. This is because the speed at which a human turns pages of a physical book has been a speed-determining condition of conventional reading training, while according to such a function of “turning pages at high speed”, it is possible to turn pages of an electronic book at speed remarkably higher than the speed at which a human turn pages of a physical book, so that said function is suitable for the new reading training for the purpose of utilizing an electronic book to read sentences at the speed in the brain.

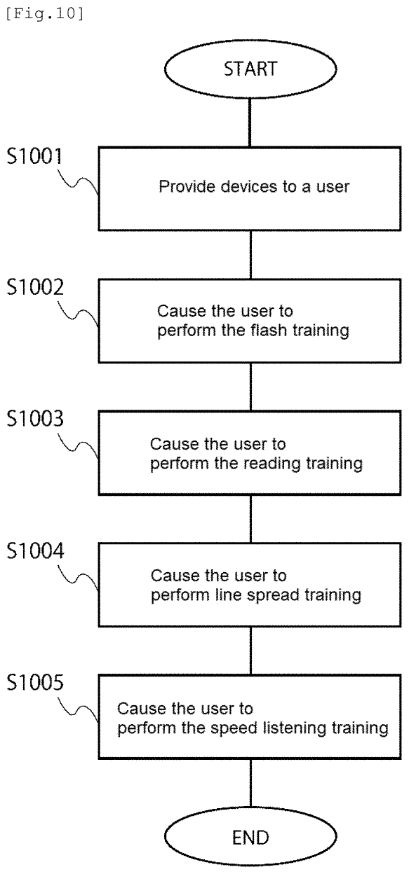

FIG. 10 shows one example of the flow of a training method for developing a user's skill. Each step shown in FIG. 10 is explained in detail hereinafter.

Step S1001: A first device comprising a means for causing a user to perform new flash training, a second device comprising a means for causing the user to perform new reading training, a third device comprising a means for causing the user to perform speed listening training, and a fourth device comprising a means for causing the user to perform line spread training are provided to the user. The new flash training is, for example, the training explained with reference to FIG. 1A to FIG. 1E. The new reading training is, for example, the training explained with reference to FIG. 2. The new line spread training is the training for increasing the number of lines that a user should read at a time explained in relation to FIG. 2. Furthermore, the first device, second device, third device and fourth device may be configured so that all of them are put together into one device, may be configured so that only a part of them are put together, or may be configured so that they are all different devices from one another.

Step S1002: The first device is used to cause the user to perform the flash training. One example of a method for using the first device to cause the user to perform the flash training is as explained with reference to FIG. 1A to FIG. 1E and Step S401 to S403 in FIG. 4.

Step S1003: The second device is used to cause the user to perform the reading training. One example of a method for using the second device to cause the user to perform the reading training is as explained with reference to FIG. 2 and FIG. 5.

Step S1004: The fourth device is used to cause the user to perform the line spread training. One example of a method for using the fourth device to cause the user to perform the line spread training is as explained with reference to FIG. 6. Furthermore, step S1004 may be omitted.

Step S1005: The third device is used to cause the user to perform the speed listening training. One example of a method for using the third device to cause the user to perform the speed listening training is as explained with reference to FIG. 7. Furthermore, step S1005 may be omitted.

The present invention has been exemplified with preferable embodiments of the present application, but the present invention should not be interpreted to be limited to the embodiments. It is understood that the scope of the present invention should be interpreted based solely on the Claims. It is understood that those skilled in the art can implement an equivalent scope from the descriptions of the specific preferred embodiments of the present invention based on the description of the present invention and common general knowledge.

### INDUSTRIAL APPLICABILITY

The present invention is useful as an invention providing a device and a program or the like for performing new training that is effective for developing skills such as speed reading regardless of the type of the language such as Japanese or English.

### REFERENCE SIGNS LIST

300 Device

310 Processor unit

320 Memory unit

330 Sound outputting unit

340 Inputting unit

350 Displaying unit

360 Touch detecting unit

1.-27. (canceled)

28. A device comprising a processor unit, a memory unit, and a displaying unit,
wherein the memory unit stores a text in a normal direction, the normal direction of the text being a direction of a text in which a rotation angle of the text is 0° to 45° or 315° to 360°,
wherein the processor unit is configured to execute at least:
reading out the text from the memory unit;
executing processing of reversing the text, or inverting the text, or inverting and reversing the text; and
instantaneously displaying the text which is reversed, or the text which is inverted, or the text which is inverted and reversed on the displaying unit,
wherein time during which the reversed text, or the inverted text, or the inverted and reversed text is instantaneously displayed is less than 0.6 seconds,
wherein the reversed text is a text in a direction in which a rotation angle of the text is 135° to 225°,
wherein the inverted text is a text wherein a text in the normal direction is inverted around a longitudinal central axis in a two-dimensional plane,
wherein the inverted and reversed text is a text which is a reversed text and which is an inverted text, and
wherein a display embodiment of the text changes when reversed or inverted.

29. The device of claim 28, wherein the memory unit stores a plurality of texts in a normal direction,
wherein the processor unit is configured to execute at least:
reading out the plurality of texts from the memory unit;
executing processing of reversing at least some of the plurality of texts, or processing of inverting at least some of the plurality of texts, or processing of inverting and reversing at least some of the plurality of texts; and
displaying at least some reversed texts, or at least some inverted texts, or at least some inverted and reversed texts among the plurality of texts in a predetermined order on the displaying unit,
wherein time during which each of the at least some reversed texts, or each of the at least some inverted texts, or each of the at least some inverted and reversed texts among the plurality of texts is instantaneously displayed is less than 0.6 seconds, and
wherein the at least some reversed texts, or the at least some inverted texts, or the at least some inverted and reversed texts among the plurality of texts include a text of which display embodiment changes when reversed or inverted.

30. The device of claim 28, wherein the memory unit stores data representing each page of a book,
wherein the processor unit is configured to further execute processing for causing a user to perform reading training,
wherein the processing for causing the user to perform reading training comprises:
reading out the data representing one page of the book from the memory unit;
displaying the one page of the book on the displaying unit;
displaying a marker on the one page of the book; and
changing a display position of the marker at a predetermined time interval.

31. The device of claim 30, wherein the processing for causing the user to perform reading training further comprises outputting a sound at the predetermined time interval, and
wherein a change in the display position of the marker is synchronized with an output of the sound.

32. The device of claim 30, wherein the processing for causing the user to perform reading training further comprises:
highlighting an area to be read indicating an area that the user should currently read on the page of the book; and
highlighting an area scheduled to be read indicating an area that the user should read next on the page of the book,
wherein the marker is displayed on the area to be read and/or the area scheduled to be read, and
wherein an embodiment of highlighting the area to be read is different from an embodiment of highlighting the area scheduled to be read.

33. The device of claim 32, wherein the processing for causing the user to perform reading training further comprises:
changing a display position of each of the area to be read and the area scheduled to be read at the predetermined time interval, and
wherein a change in the display position of each of the area to be read and the area scheduled to be read is synchronized with a change in the display position of the marker.

34. The device of claim 30, wherein the marker comprises a touch detecting area that is able to detect a touch operation by a user, and
wherein the processing for causing the user to perform reading training further comprises:
determining whether a touch operation to the touch detecting area has been detected while the marker is displayed; and
outputting a result of the determination.

35. The device of claim 30, wherein the processor unit is configured to further execute evaluating a result of training of instantaneously displaying the text,
wherein the processing for causing the user to perform reading training further comprises setting an initial condition of the reading training based on a result of the evaluation.

36. The device of claim 35, wherein the initial condition comprises at least one of: a predetermined time interval of a sound generated from the device; or the number of display positions of the marker per page.

37. The device of claim 28, wherein the memory unit stores data representing each page of a book,
wherein the processor unit is configured to further execute processing for causing a user to perform line spread training,
wherein the processing for causing the user to perform line spread training comprises:
reading out the data representing one page of the book from the memory unit;
displaying the one page of the book on the displaying unit;
displaying a marker on the one page of the book;
detecting that the user has touched the one page of the book; and
changing a display position of the marker in response to detecting that the user has touched the one page of the book.

38. The device of claim 37, wherein the processing for causing a user to perform line spread training further comprises;
highlighting an area to be read indicating an area that the user should currently read on the page of the book; and
highlighting an area scheduled to be read indicating an area that the user should read next on the page of the book,
wherein the marker is displayed on the area to be read and/or the area scheduled to be read, and
wherein an embodiment of highlighting the area to be read is different from an embodiment of highlighting the area scheduled to be read.

39. The device of claim 38, wherein the processing for causing the user to perform line spread training further comprises:
changing a display position of each of the area to be read and the area scheduled to be read in response to detecting that the user has touched the one page of the book, and
wherein a change in the display position of each of the area to be read and the area scheduled to be read is synchronized with a change in the display position of the marker.

40. The device of claim 37, wherein the processor unit is configured to further execute evaluating a result of training in which the user reads the text which is instantaneously displayed on the displaying unit, and
wherein the processing for causing the user to perform line spread training further comprises setting an initial condition of the line spread training based on a result of the evaluation.

41. The device of claim 40, wherein the initial condition comprises the number of display positions of the marker per page.

42. The device of claim 28, wherein the processor unit is configured to further execute processing for causing a user to perform speed listening training, and
wherein the processing for causing the user to perform speed listening training comprises:
setting an output speed scale factor of a sound to be output; and
outputting the sound to be output at the set output speed scale factor.

43. The device of claim 42, wherein the processing for causing the user to perform speed listening training further comprises identifying the sound to be output.

44. The device of claim 42, wherein the processor unit is configured to further execute evaluating a result of training in which the user reads the text which is instantaneously displayed on the displaying unit, and
wherein the processing for causing the user to perform speed listening training further comprises setting an initial condition of the speed listening training based on a result of the evaluation.

45. A program executed in a device, the device comprising a processor unit, a memory unit, and a displaying unit,
wherein the memory unit stores a text in a normal direction, the normal direction of the text being a direction of a text in which a rotation angle of the text is 0° to 45° or 315° to 360°,
wherein the program, when executed in the processor unit, causes the processor unit to execute at least:
reading out the text from the memory unit;
executing processing of reversing the text, or inverting the text, or inverting and reversing the text; and
instantaneously displaying the text which is reversed, or the text which is inverted, or the text which is inverted and reversed on the displaying unit,
wherein time during which the reversed text, or the inverted text, or the inverted and reversed text is instantaneously displayed is less than 0.6 seconds,
wherein the reversed text is a text in a direction in which a rotation angle of the text is 135° to 225°,
wherein the inverted text is a text wherein a text in the normal direction is inverted around a longitudinal central axis in a two-dimensional plane,
wherein the inverted and reversed text is a text which is a reversed text and which is an inverted text, and
wherein a display embodiment of the text changes when reversed or inverted.

46. A method for training a user's brain by utilizing a first device and a second device,
the first device comprising a first processor unit, a first memory unit, and a first displaying unit,
wherein the first processor unit is configured to execute at least processing for causing the user to perform flash training,
wherein the processing for causing the user to perform flash training comprises instantaneously displaying a reversed text, or an inverted text, or an inverted and reversed text on the first displaying unit,
wherein time during which the reversed text, or the inverted text, or the inverted and reversed text is instantaneously displayed is less than 0.6 seconds,
wherein the normal direction of the text is a direction of a text in which a rotation angle of the text is 0° to 45° or 315° to 360°,
wherein the reversed text is a text in a direction in which a rotation angle of the text is 135° to 225°,
wherein the inverted text is a text wherein a text in the normal direction is inverted around a longitudinal central axis in a two-dimensional plane,
wherein the inverted and reversed text is a text which is a reversed text and which is an inverted text, and
wherein a display embodiment of the text changes when reversed or inverted,
the second device comprising a second processor unit, a second memory unit, and a second displaying unit,
wherein the second memory unit stores data representing each page of a book,
wherein the second processor unit is configured to execute at least processing for causing a user to perform reading training,
wherein the processing for causing the user to perform reading training comprises:
reading out the data representing one page of the book from the second memory unit;
displaying the one page of the book on the second displaying unit;
displaying a marker on the one page of the book; and
changing a display position of the marker at a predetermined time interval, and
wherein the method comprises:
causing the user to perform flash training by executing the processing for causing the user to perform flash training by the first processor unit of the first device; and
causing the user to perform reading training by executing the processing for causing the user to perform reading training by the second processor unit of the second device.

47. The method of claim 46, further utilizing a third device,
wherein the third device comprises a third processor unit,
wherein the third processor unit is configured to execute at least processing for causing the user to perform speed listening training,
wherein the processing for causing the user to perform speed listening training comprises:
setting an output speed scale factor of a sound to be output; and
outputting the sound to be output at the set output speed scale factor, and
wherein the method further comprises:
causing the user to perform speed listening training by executing the processing for causing the user to perform speed listening training by the third processor unit of the third device.

48. The method of claim 46, further utilizing a fourth device,
wherein the fourth device further comprises a fourth processor unit, a fourth memory unit, and a fourth displaying unit,
wherein the fourth memory unit stores data representing each page of a book,
wherein the fourth processor unit is configured to execute at least processing for causing the user to perform line spread training,
wherein the processing for causing the user to perform line spread training comprises:
reading out the data representing one page of the book from the fourth memory unit;
displaying the one page of the book on the fourth displaying unit;
displaying a marker on the one page of the book;
detecting that the user has touched the one page of the book; and
changing a display position of the marker in response to detecting that the user has touched the one page of the book, and
wherein the method further comprises:
causing the user to perform line spread training by executing the processing for causing the user to perform line spread training by the fourth processor unit of the fourth device.
